(19) United States
(12) Patent Application Publication
(10) Pub. No.: US 2011/0197684 A1
(43) Pub. Date: Aug. 18, 2011

(54) EPSILON-SHAPED MICROCANTILEVER ASSEMBLY WITH ENHANCED DEFLECTIONS FOR SENSING, COOLING, AND MICROFLUIDIC APPLICATIONS

(76) Inventors: Kambiz Vafai, Mission Viejo, CA (US); Abdul Rahim A. Khaled, Jeddah (SA)

(21) Appl. No.: 13/095,530

(22) Filed: Apr. 27, 2011

Related U.S. Application Data
(63) Continuation-in-part of application No. 12/793,826, filed on Jun. 4, 2010.
Application No. 12/793,826 is a continuation of application No. 11/184,932, filed on Jul. 20, 2005, now Pat. No. 7,770,809.
Application No. 11/184,932 is a continuation-in-part of application No. 10/840,303, filed on May 7, 2004, now Pat. No. 7,654,468.
(60) Provisional application No. 60/470,850, filed on May 16, 2003.

(51) Int. Cl. G01L 1/22; B23P 17/00

(52) U.S. Cl. 73/862.634; 29/527.2

(57) ABSTRACT

An assembly of microcantilever-based sensors with enhanced deflections. A deflection profile of an ε-assembly can be compared with that of a rectangular microcantilever and a modified triangular microcantilever. Various force-loading conditions can also be considered. A theorem of linear elasticity for thin beams is utilized to obtain the deflections. The obtained defections can be validated against an accurate numerical solution utilizing a finite element method with a maximum deviation of less than 10 percent. The ε-assembly produces larger deflections than the rectangular microcantilever under the same base surface stress and same extension length. Also, the ε-microcantilever assembly produces a larger deflection than a modified triangular microcantilever. The deflection enhancement increases as the ε-assembly's free length decreases for various types of force loading conditions. The ε-microcantilever can be utilized in microsensing applications to provide a favorable high detection capability with a reduced susceptibility to external noises.

### CROSS-REFERENCE TO RELATED APPLICATIONS

This patent application is a Continuation-in-Part of U.S. patent application Ser. No. 12/793,826, entitled “Methods and Devices Comprising Flexible Seals, Flexible Microchannels, or Both for Modulating or Controlling Flow and Heat” filed on Jun. 6, 2010, which in turn is a continuation of U.S. patent application Ser. No. 11/184,932, entitled “Methods and Devices Comprising Flexible Seals, Flexible Microchannels, or Both For Modulating or Controlling Flow and Heat,” which was filed on Jul. 20, 2005, the disclosure of which is incorporated herein by reference in its entirety. U.S. patent application Ser. No. 11/184,932 in turn is a continuation-in-part of U.S. patent application Ser. No. 10/840,303, filed 7 May 2004, which claims the benefit of U.S. Provisional Patent Application No. 60/470,850 filed 16 May 2003, which are herein incorporated by reference in their entirety.

### TECHNICAL FIELD

Embodiments generally relate to sensors with enhanced deflections comprising microcantilever-based sensors.

### BACKGROUND OF THE INVENTION

The rapid growth of nanotechnology has led to developments of new sensing devices of micrometer size coined as microsensors. These devices can be used to detect, measure, analyze, and economically monitor low concentrations of chemical and biological agents. The monitoring of a specific substance is pivotal in many applications especially for clinical purposes. This is in order to screen a patient for the presence of a disease at an early stage. Microcantilevers based microsensors have been proven to be very sensitive and accurate. See Wu G, Ji H, Hansen K, Thundat T, Datar R, Cote R, Hagan M F, Chakraborty A K, and Majumdar A (2001) Origin of Nanomechanical cantilever motion generated from biomolecular interactions, PNAS, 98:1560-1564.

The changes in the physical properties of the microcantilever are considered to indicate or detect changes in the environment surrounding it. The most often considered physical property is the deflection. The deflection of the microcantilever was first used for atomic force microscopy. However, it is mainly used to indicate the presence or absence of a certain analyte. See Alkamine S, Barrett R. C., and Quate C. F. (1990) Improved atomic force microscope images using microcantilevers with sharp tips, Appl. Phys. Lett., 57:316 and Raiteri R, Nelles G, Butt H-J, Knoll W, and Skladal P (1999) Sensing of biological substances based on the bending of the microfabricated cantilevers, Sens. Actuators B, 61:213-217.

The magnitude of microcantilever deflection is of the order of nanometers and it is usually measured using an optical method. The noise level in the surrounding environment affects the performance of the microcantilever as a sensing device. For example, Raiteri R, Nelles G, Butt H-J, Knoll W, and Skladal P (1999), Sensing of biological substances based on the bending of the microfabricated cantilevers, Sens. Actuators B, 61:213-217 reported that the microcantilever deflection due to flow disturbances and due to thermal effects could reach 5-10 times that due to analyte sensing. Accordingly, further developments in microcantilever technology is necessary in order to magnify the deflection signal due to the sensing effect so that its signal can be easily distinguished from the noise signal. See Fritz J, Bailer M K, Lang H P, Rothuizen H, Vettiger P, Meyer E, Guntherodt H-J, Gerber Ch, and Gimzewski J K (2000) Translating biomolecular recognition into nanomechanics, Science, 288:316-8, Yang M, Zhang X, Vafai K, and Ozkan C S (2003) High sensitivity piezoresistive cantilever design and optimization for an analyte-receptor binding, J. Micromech. Microeng., 13:864-72, and Khaled A.-R. A. and Vafai, K. (2004) Optimization modelling of analyte adhesion over an inclined microcantilever-based biosensor, J. Micromech. Microeng., 14:1220-29. As such, Khaled A-R A, Vafai K, Yang M, Zhang X, and Ozkan C S (2003) Analysis, control and augmentation of microcantilever deflections in bio-sensing systems, Sens. Actuators B, 94:103-115, pointed out the necessity of establishing special microcantilevers assemblies for this purpose.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is therefore one aspect of the disclosed embodiments to provide for an epsilon-shaped microcantilever and assembly thereof that can be employed in a variety sensing, cooling, and/or microfluidic applications.

It is another aspect of the disclosed embodiments to provide for an epsilon-shaped microcantilever and assembly thereof having at least a first beam, a second beam, and an intermediate beam.

It is yet another aspect of the disclosed embodiments to provide for an epsilon-shaped microcantilever and assembly thereof with enhanced deflections for sensing applications.

The aforementioned aspects and other objectives and advantages can now be achieved as described herein. An epsilon-shaped microcantilever is disclosed, which includes a first side beam, a second side beam, and an intermediate beam, wherein the first side beam comprises an end attached to an end of the second side beam. The intermediate beam comprises an end attached to the ends of the first and second side beams such that the intermediate beam is positioned between the first and second side beams. Additionally, the ends opposite to the attached ends of the first side beam, second side beam, and intermediate beam are left free and are force-loaded. The first side beam, the second side beam, and the intermediate beam each possess a top surface and a bottom surface. The epsilon-shaped microcantilever can also include a receptor coated on the top surfaces of the first and second side beams and on the bottom surface of the intermediate beam.

Varying force loadings including at least one of a concentrated force, a concentrated moment, and a constant surface stress can be utilized with respect to the epsilon-shaped microcantilever assembly disclosed herein. In general, a deflection theory of thin beams can be utilized to obtain a deflection profile with respect to the epsilon-shaped microcantilever assembly disclosed herein. Obtained deflections of the epsilon-shaped assembly can be validated against an accurate numerical solution utilizing a finite element method with a maximum deviation of less than approximately ten percent. Additionally, the deflection enhancement increases as the free length decreases for various types of force loading conditions with respect to the disclosed epsilon-shaped microcantilevers assembly.

### DESCRIPTION OF THE DRAWINGS

This invention is further understood by reference to the drawings wherein:

FIG. 1 is a schematic diagram and the coordinate system of Rectangular microcantilever assembly.

FIG. 2 is a schematic diagram and the coordinate system of modified triangular microcantilever assembly.

FIG. 3 is a schematic diagram and the coordinate system of ε-microcantilever assembly.

FIG. 4 shows the deflection profile for assembly of FIG. 1 using numerical solutions with L=385 μm, W=30 μm, t=20 nm, M=10⁻¹² Nμm, E=0.185 Nμm⁻², and v=0.33.

FIG. 5 shows the effects of the relative dimensions of the modified triangular and ε-microcantilevers assemblies on the first performance indicators γ_{bF} and γ_{cF}.

FIG. 6 shows the effects of the relative dimensions of the modified triangular and ε-microcantilevers assemblies on the first performance indicators γ_{bM} and γ_{cM}.

FIG. 7 shows the effects of the relative dimensions of the modified triangular and ε-microcantilevers assemblies on the first performance indicators γ_{bΔσ} and γ_{cΔσ}.

FIG. 8 shows the effects of the relative dimensions of the modified triangular and ε-microcantilevers assemblies on the second performance indicators λ_{cF}.

FIG. 9 shows the effects of the relative dimensions of the modified triangular and ε-microcantilevers assemblies on the second performance indicators λ_{cM}.

FIG. 10 shows the effects of the relative dimensions of the modified triangular and ε-microcantilevers assemblies on the second performance indicators λ_{cΔσ}.

### DETAILED DESCRIPTION OF THE INVENTION

The following Table 1 provides the various symbols and meanings used in this section:

TABLE 1
Nomenclature:

| | |
|---|---|
| B | Base length of the microcantilever assembly |
| E | Elastic modulus (N μm⁻²) |
| F | concentrated force (N) |
| I | Area moment of inertia (μm⁴) |
| L | microcantilever or assembly extension length (μm) |
| M | moment (N μm) |
| n | surface stress model index |
| t | microcantilever thickness (μm) |
| W | microcantilever width (μm) |
| x | axis of the extension dimension (μm) |
| Y | effective elastic modulus (N μm⁻²) |
| z | deflection (μm) |

Greek symbols:

| | |
|---|---|
| γ | first deflection indicator |
| λ | second deflection indicator |
| ν | Poisson's ratio |
| σ | surface stress |

Subscripts:

| | |
|---|---|
| F | concentrated force condition |
| M | moment condition |
| Δσ | constant differential surface stress condition |

Abbreviations:

| | |
|---|---|
| IB | the intermediate beam of ε-assembly |
| SB | the side beams of ε-assembly |

The accompanying figures, in which like reference numerals refer to identical or functionally similar elements throughout the separate views and which are incorporated in and form a part of the specification, further illustrate the present invention and, together with the detailed description of the invention, serve to explain the principles of the disclosed embodiments.

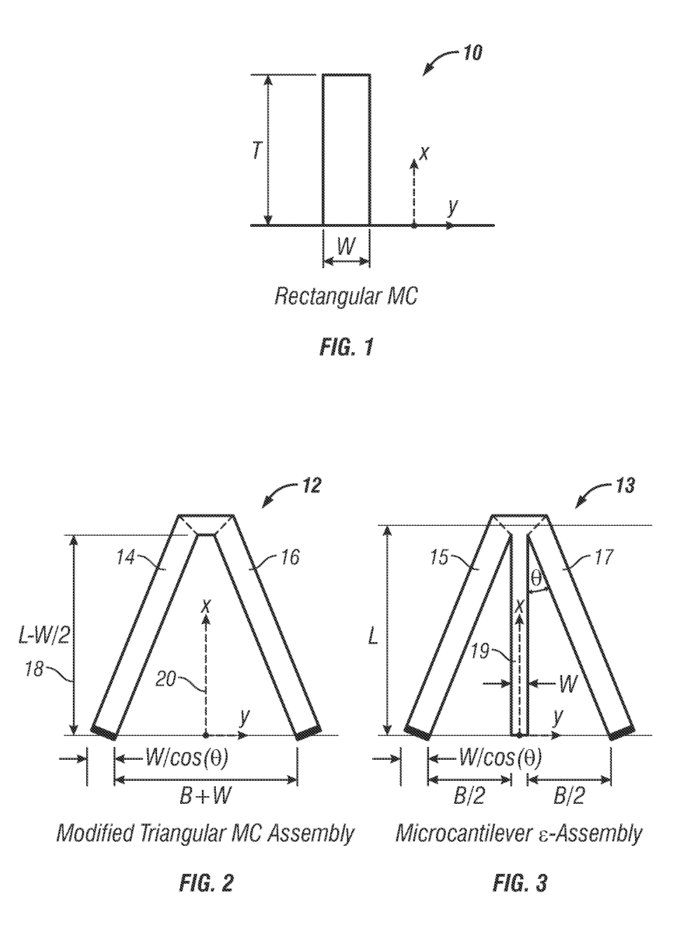

FIG. 1 illustrates a schematic diagram depicting the geometry of a rectangular microcantilever (MC) 10. Specifying the extension length L, width W, thickness t, Young's modulus E, and Poisson's ratio can summarize the properties of the rectangular microcantilever 10 v. When the length of the microcantilever is much larger than its width, Hooks law for small deflections can be utilized to relate the microcantilever deflections to the effective elastic modulus Y and the bending moment M, and can be represented by the following equation (1):

$$\frac{{d}^{2} z}{d {x}^{2}} = \frac{M}{YI} \qquad Eq . 1$$

In the formulation above, the variable z is the deflection of the microcantilever at any section located at a position x from the base surface. I is the area moment of inertia of the microcantilever cross-section about its neutral axis. For a rectangular cross-section with its neutral axis coinciding with its centroidal axis, I is given by equation (2) below:

$$I = \frac{1}{12} {Wt}^{3} \qquad Eq . ( 2 )$$

The boundary conditions for Equation (1) are given by

$$z ( x = 0 ) = \frac{d z}{d x} {\vert}_{x = 0} = 0 \qquad Eqs . 3 ( a , b )$$

For a concentrated force exerted on the rectangular microcantilever tip (x=L), the solution of Equation (1), denoted by z_{aF}(χ), subject to boundary conditions given by Equations 3 (a, b) can be expressed as:

$${z}_{aF} ( x ) = ( \frac{6 {FL}^{3}}{{EWt}^{3}} ) [ {( \frac{x}{L} )}^{2} - \frac{1}{3} {( \frac{x}{L} )}^{3} ] \qquad Eq . ( 4 )$$

The above result is based on a realistic linearly increasing bending moment from the base prescribed by:

$$M = FL ( 1 - \frac{x}{L} ) \qquad Eq . ( 5 )$$

For thin cross-sections, the surface stress, σ, can be calculated from the following equation:

$$σ = \frac{M}{I} ( \frac{t}{2} ) \qquad Eq . ( 6 )$$

The surface stress at x=0 (base surface) denoted by σ_{aFo} is equal to

$${σ}_{aFo} = \frac{6 FL}{{Wt}^{2}} \qquad Eq . ( 7 )$$

The maximum deflection which occurs at the microcantilever tip (x=L) can be expressed as indicated by equation (8) below:

$${z}_{aF max} = \frac{4 {FL}^{3}}{{EWt}^{3}} \qquad Eq . ( 8 )$$

For a bending moment M exerted on the rectangular microcantilever tip (x=L), the solution of Equation (1), denoted by z_{aM}(χ), subject to boundary conditions given by Equations 3 (a, b) can be expressed as:

$${z}_{aM} ( x ) = ( \frac{6 {ML}^{2}}{{EWt}^{3}} ) {( \frac{x}{L} )}^{2} \qquad Eq . ( 9 )$$

The surface stress at the base section which is denoted by σ_{aMo} is equal to:

$${σ}_{aMo} = \frac{6 M}{{Wt}^{2}} \qquad Eq . ( 10 )$$

The maximum deflection which is the deflection at the microcantilever tip is equal to:

$${z}_{aM max} = \frac{6 {ML}^{2}}{{EWt}^{3}} \qquad Eq . ( 11 )$$

When the microcantilever is coated on one side with a thin film of receptor, it is usually bent due to analyte adhesion on that layer. This adhesion causes a differential in the surface stress across the microcantilever section yielding a bending moment at each section. The bending moment M [1, 8] is given by equation (12) below:

$$M = \frac{Δ σ Wt}{2} \qquad Eq . ( 12 )$$

wherein Δσ is the difference between the surface stresses of the top and bottom sides of the microcantilever. The solution of Eq. (1), denoted by z_{aΔσ}(χ), subject to boundary conditions given by Equations 3 (a, b) can then be expressed by equation (13) below:

$${z}_{a Δ σ} ( x ) = \frac{6 ( 1 - v ) Δ {σ}_{o} {L}^{2}}{{Et}^{2} ( n + 1 ) ( n + 2 )} {( \frac{x}{L} )}^{n + 2} \qquad Eq . ( 13 )$$

This is because the effective elastic modulus for this case is given by Y=E/(1−v). Also, Δσ is considered to vary along the microcantilever length according to the following relationship of equation (14):

$$Δσ = {{Δσ}_{o} ( \frac{x}{L} )}^{n} \qquad Eq . ( 14 )$$

wherein n is the model index. This variation is expected as analyte concentration in the surrounding environment and is expected to increase as the distance from the microcantilever base increases. The maximum deflection due to analyte adhesion is obtained from Equation 205 by substituting x=L. It is equal to:

$${z}_{a Δσ mmax} ( x ) = \frac{6 ( 1 - v ) {Δσ}_{o} {L}^{2}}{{Et}^{2} ( n + 1 ) ( n + 2 )} \qquad Eq . ( 15 )$$

Equation (15) is reducible to the Stoney's equation when n is set to be equal to zero.

FIG. 2 illustrates a schematic diagram depicting the geometry of a microcantilever assembly 12. The microcantilever assembly 12 shown in FIG. 2 includes an SB (Side Beam) 14 and an SB 16. The microcantilever assembly 12 depicted in FIG. 2 constitutes a modified triangular MC assembly, as opposed to the rectangular MC 10 depicted in FIG. 1.

Equation (1) is changeable to the following when the center line of the free end (x=L) is loaded by a normal concentrated force of magnitude F:

$$\frac{{d}^{2} {z}_{bF}}{d {x}^{2}} = ( \frac{3 FL}{{EWt}^{3}} ) \times 2 ( 1 - x / L ) / {cos}^{3} ( θ ) \qquad Eq . ( 16 )$$

Note that I for each beam is I=Wt³/12. Note that θ is half the triangular tip angle. The cosine of the angle θ is given by:

$$cos ( θ ) = {[ 1 + {0.25 [ \frac{B / L}{1 - 0.5 ( W / L )} ]}^{2} ]}^{- 1 / 2} \qquad Eq . ( 17 )$$

The boundary conditions for Equation 208 are given by:

$${z}_{b} ( x = 0 ) = \frac{d {z}_{b}}{d x} {\vert}_{x = 0} = 0 \qquad Eqs . 18 ( a , b )$$

The solution of Equation (16), denoted by z_{bF}(χ), subject to the above boundary conditions is the following:

$${z}_{bF} ( x ) = ( \frac{3 {FL}^{3}}{{EWt}^{3}} ) [ {( \frac{x}{L} )}^{2} - \frac{1}{3} {( \frac{x}{L} )}^{3} ] ( \frac{1}{{cos}^{3} ( θ )} ) \qquad Eq . 19 ( a )$$

Using Equation (6), the surface stress at x=0, σ_{bFo}, is equal to:

$${σ}_{bFo} = ( \frac{3 FL}{{Wt}^{2}} ) [ \frac{1}{cos ( θ )} ] \qquad Eq . ( 20 )$$

The maximum deflection occurs at the tip (x=L). It is equal to:

$${z}_{bF max} = ( \frac{3 {FL}^{3}}{{EWt}^{3}} ) \{ \frac{2}{3 {cos}^{3} ( θ )} \} \qquad Eq . ( 21 )$$

For a bending moment M about x-axis exerted on the centerline of the free end of the assembly (b) (at x=L), Equation (3) is changeable to the following form:

$$\frac{{d}^{2} {z}_{bM}}{d {x}^{2}} = ( \frac{3 M}{{EWt}^{3}} ) \times 2 / cos ( θ ) \qquad Eq . ( 22 )$$

the solution of Equation (22), subject to boundary conditions given by Equation 18 (a, b) is the following:

$${z}_{bM} ( x ) = ( \frac{2 {ML}^{2}}{{EWt}^{3}} ) {( \frac{x}{L} )}^{2} [ \frac{1}{cos ( θ )} ] \qquad Eq . ( 23 )$$

As such, the maximum deflection is expected to be equal to:

$${z}_{bM max} = ( \frac{3 {ML}^{2}}{{EWt}^{3}} ) \{ \frac{1}{cos ( θ )} \} \qquad Eq . ( 24 )$$

Using Equation (6), the surface stress at x=0, σ_{cMo}, is equal to:

$${σ}_{bMo} = \frac{3 M}{{Wt}^{2}} cos ( θ ) \qquad Eq . ( 25 )$$

When a receptor layer is coated on one side of assembly (b)-side beams (SB), Equation (3) changes to the following form after the analyte adhesion on these coatings:

$$\frac{{d}^{2} {z}_{b Δσ}}{d {x}^{2}} = \{ \frac{6 ( 1 - v ) {Δσ}_{o}}{{Et}^{2}} \} \times {( x / L )}^{n} / {cos}^{2} ( θ ) \qquad Eq . ( 26 )$$

The solution of Equation (26), subject to boundary conditions given by Equation (18) (a, b) is the following:

$${z}_{b Δσ} ( x ) = \{ \frac{6 ( 1 - v ) {Δσ}_{o} {L}^{2}}{{Et}^{2} ( n + 1 ) ( n + 2 )} \} {( \frac{x}{L} )}^{n + 2} [ \frac{1}{{cos}^{2} ( θ )} ] \qquad Eq . ( 27 )$$

The maximum deflection due to analyte adhesion is then equal to:

$${z}_{b Δσ m max} = \{ \frac{6 ( 1 - v ) {Δσ}_{o} {L}^{2}}{{Et}^{2}} \} \{ \frac{1 / {cos}^{2} ( θ )}{( n + 1 ) ( n + 2 )} \} \qquad Eq . ( 28 )$$

Define the first deflection indicator γ_{pU} as the ratio of the microcantilever deflection at the tip (x=L) per surface stress at the base for the microcantilever of type (p) due to force loading of type U to the corresponding value for the rectangular microcantilever. The type (p) can be either the microcantilever type shown in FIG. 2 or the type depicted in FIG. 3. The force loading of type U can be either a concentrated force loading (F), an external bending moment (M) or a constant surface stress (Δσₒ). As such, γ_{bF}, γ_{bM} and γ_{bΔσ}_{ₒ} are equal to

$$\begin{matrix}{γ}_{bF} = 1 / {cos}^{3} ( θ ) & Eq . 29 ( a ) \\ {γ}_{bM} = \frac{1}{{cos}^{2} ( θ )} & Eq . 29 ( b ) \\ {γ}_{b Δ {σ}_{o}} = 1 / {cos}^{2} ( θ ) & Eq . 29 ( c )\end{matrix}$$

### The Microcantilever ε-Assembly

FIG. 3 illustrates a schematic diagram of an epsilon (ε) shaped microcantilever or MC assembly 13, in accordance with the disclosed embodiments. The MC assembly 13 shown in FIG. 3 includes a SB 15 and a SB 17 along with an IB (Intermediate Beam) 19, which together form the epsilon (ε) shaped microcantilever or MC assembly 13. In order to configure the geometry of the microcantilever assembly 13 shown in FIG. 3, the centerline of the assembly free end (x=L) can be loaded by a normal concentrated force of magnitude F. Additionally, the free end of the intermediate beam (IB) 19 can be loaded by the negative of the previous load (−F). Accordingly, Equation (3) changes to the following:

$$\frac{{d}^{2} {z}_{cF}}{d {x}^{2}} = ( \frac{3 FL}{{EWt}^{3}} ) \times [ \begin{matrix}2 / cos ( θ ) , & ( for SB ) \\ - 4 ( x / L ) , & ( for IB )\end{matrix} \qquad Eq . ( 30 )$$

wherein SB stands for the side beams of the assembly. The boundary conditions of Equation (30) can be given by:

$$\begin{matrix}{z}_{cSB} ( x = 0 ) = \frac{d {z}_{cSB}}{d x} {\vert}_{x = 0} = 0 & Eq . 31 ( a ) \\ {z}_{cSB} ( x = L ) = {z}_{cIB} ( x = L ) & Eq . 31 ( b ) \\ \frac{d {z}_{cSB}}{d x} {\vert}_{x = L} = \frac{d {z}_{cIB}}{d x} {\vert}_{x = L} & Eq . 31 ( c )\end{matrix}$$

The solution of Equation 30, denoted by z_{cF}(χ), is equal to:

$$\begin{matrix} {z}_{cSBF} ( x ) = ( \frac{3 {FL}^{3}}{{EWt}^{3}} ) {( \frac{x}{L} )}^{2} [ \frac{1}{cos ( θ )} ] & Eq . 32 ( a ) \\ {z}_{cIBF} ( x ) = ( \frac{3 {FL}^{3}}{{EWt}^{3}} ) \{ - ( \frac{2}{3} ) {( \frac{x}{L} )}^{3} + 2 ( \frac{1}{cos ( θ )} + 1 ) ( \frac{x}{L} ) + {D}_{1} \} & Eq . 32 ( b )\end{matrix}$$

wherein D₁ is equal to:

$${D}_{1} = - \{ \frac{1}{cos ( θ )} + \frac{4}{3} \} \qquad Eq . 32 ( c )$$

The surface stress at the base section σ_{cFo} is equal to:

$${σ}_{cFo} = ( \frac{3 FL}{{Wt}^{2}} ) cos ( θ ) \qquad Eq . 33$$

The second deflection indicator λ_{dU} can be defined as the ratio of the IB-free end deflection z_{cIBU}(χ=0) to that at the assembly free end z_{cU}(χ=L) due to force loading of type U. The force loading of type U can be either the current described force loading (F), external bending moment loading (M) or the constant surface stress (Δσₒ) loading. The last two types of force loadings will be described later on. As such, λ_{cF} is equal to:

$${λ}_{cF} = \frac{{zc}_{dIBF} ( x = 0 )}{{z}_{cF} ( x = L )} = - \{ 1 + \frac{4}{3} cos ( θ ) \} \qquad Eq . 34$$

Now, let a bending moment M be exerted on the free end centerline of the MC assembly 13 and let another bending moment of same magnitude be exerted on the IB-free end at x=0. The deflection equations for this assembly under the current moments loading is given by the following:

$$\frac{{d}^{2} {z}_{cM}}{d {x}^{2}} = ( \frac{6 M}{{EWt}^{3}} ) \times [ \begin{matrix}2 / cos ( θ ) , & ( for SB ) \\ - 2 , & ( for IB )\end{matrix} \qquad Eq . 35$$

The boundary conditions are given by Equations 31 (a-c). The solution of Equation 35 is given by:

$$\begin{matrix}{z}_{cSBM} ( x ) = \frac{1}{cos ( θ )} ( \frac{6 {ML}^{2}}{{EWt}^{3}} ) {( \frac{x}{L} )}^{2} & Eq . 36 ( a ) \\ {z}_{cIBM} ( x ) = ( \frac{6 {ML}^{2}}{{EWt}^{3}} ) \{ - {( \frac{x}{L} )}^{2} + 2 ( \frac{1}{cos ( θ )} + 1 ) ( \frac{x}{L} ) + {D}_{2} \} & Eq . 36 ( b )\end{matrix}$$

wherein D₂ is equal to:

$${D}_{2} = - [ \frac{1}{cos ( θ )} + 1 ] \qquad Eq . 36 ( c )$$

the surface stress at x=0, σ_{cMo}, is equal to:

$${σ}_{cMo} = \frac{6 M}{{Wt}^{2}} cos ( θ ) \qquad Eq . 39$$

The second deflection indicator for assembly (c) (i.e., FIG. 3) for the current moments loading λ_{cM} is equal to:

$${λ}_{cM} = \frac{{z}_{cIBM} ( x = 0 )}{{z}_{cM} ( x = L )} = - [ cos ( θ ) + 1 ] \qquad Eq . 40$$

If the top surfaces of the side beams of MC assembly 13 can be coated with a receptor while the receptor coating on the intermediate beam is on its bottom surface, then the deflection equations of the MC assembly 13 changes to:

$${cos}^{2} ( θ ) \times \frac{{d}^{2} {z}_{cSB Δ σ}}{d {x}^{2}} = - \frac{{d}^{2} {z}_{cIB Δ σ}}{d {x}^{2}} = \frac{6 ( 1 - v ) {Δσ}_{o}}{{Et}^{2}} {( \frac{x}{L} )}^{n} \qquad Eq . 41$$

The solution for Equation 41 subject to boundary conditions given by Equations 223(a-c) is equal to:

$$\begin{matrix} {z}_{cSB Δ σ} ( x ) = \{ \frac{6 ( 1 - v ) Δ {σ}_{o} {L}^{2}}{E ( n + 1 ) {t}^{2}} \} {( \frac{x}{L} )}^{n + 2} \{ \frac{1 / {cos}^{2} ( θ )}{n + 2} \} & Eq . 42 ( a ) \\ {z}_{cIB Δ σ} ( x ) = \{ \frac{6 ( 1 - v ) Δ {σ}_{o} {L}^{2}}{E ( n + 1 ) {t}^{2}} \} \{ \frac{- 1}{( n + 2 )} {( \frac{x}{L} )}^{n + 2} + [ 1 + \frac{1}{{cos}^{2} ( θ )} ] [ \frac{x}{L} - \frac{n + 1}{n + 2} ] \} & Eq . 42 ( b )\end{matrix}$$

The deflection indicator for MC assembly 13 due to the alternating analyte adhesion on the surfaces λ_{cΔσ} is equal to:

$${λ}_{c Δ σ} = \frac{{z}_{cIB Δ σ} ( x = 0 )}{{z}_{cSB Δ σ} ( x = L )} = - ( n + 1 ) [ {cos}^{2} ( θ ) + 1 ] \qquad Eq . 43$$

The deflection indicators γ_{cF}, γ_{cM} and γ_{cΔσ}_{ₒ} can be shown to be equal to the following:

γ_{cF}=1.5/cos²(θ) Eq. 44(a)

γ_{cM}=1/cos²(θ) Eq. 44(b)

γ_{cΔσ}_{ₒ}=1/cos²(θ) Eq. 44(c)

### Validation

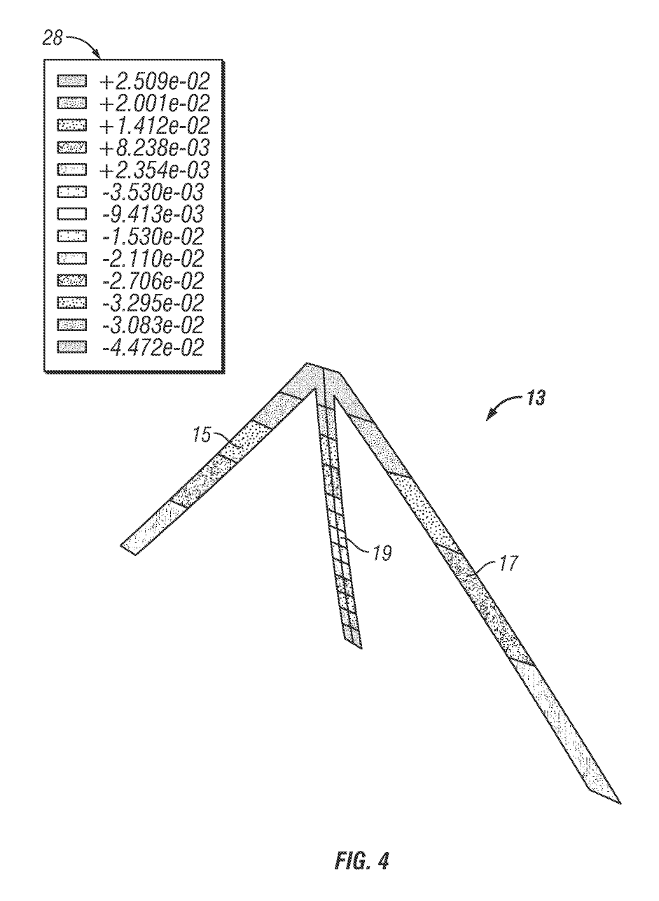

Note that present analytical methods were tested against an accurate numerical solution using finite element methods and accounting for all mechanical constraints induced by the assemblies. Among these constraints is restraining the wrapping of the side beams due to the presence of the small connecting beam at x=L. The deflection contours for assembly (c) with L=385 μm, W=30 μm and t=20 nm under concentrated moment condition described in section 2.2.II with M=10⁻¹² Nμm is shown in FIG. 4. The microcantilever material was taken to be silicon with E=0.185 Nμm⁻² and a poisons ratio of v=0.33. The assembly deflection at x=L is equal to z_{cM}(χ=L)=0.028 μm using Equation (36)(b). Also, the deflection at the intermediate beam's free end can be shown to be equal to z_{cIBM}(χ=0)=0.048 μm.

As can be seen from FIG. 4, the corresponding numerical values of those deflections are equal to 0.026 μm and 0.045 μm, respectively. Notice that the maximum error between the numerical and the derived analytical solutions is less than 10 percent. Also, notice that the numerical values of deflections are smaller than those predicated by the analytical methods. This is because the geometrical constraints imposed on the assemblies impede the deflections.

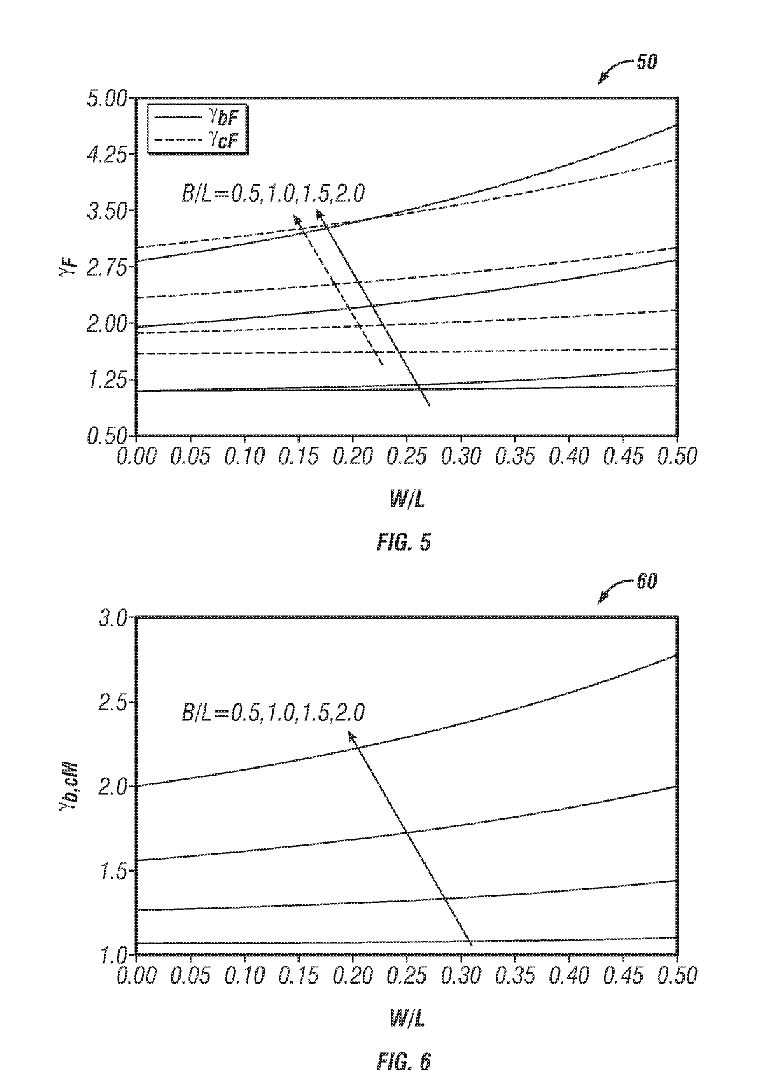

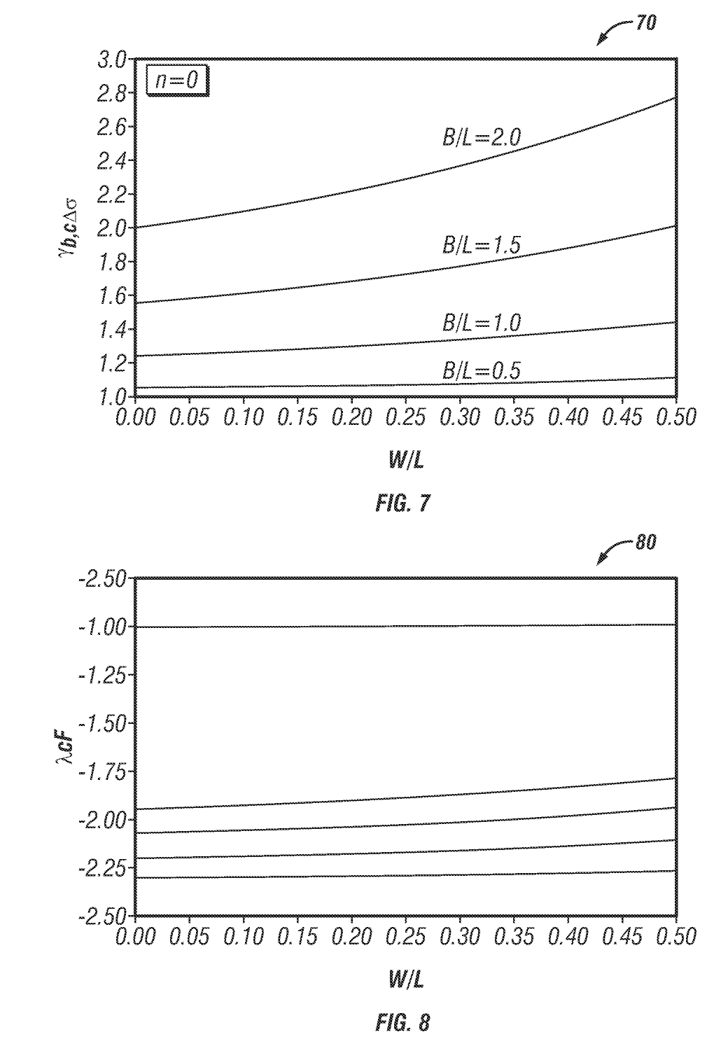

FIG. 5 illustrates a graph 50 depicting plotted data indicative of the variation of the performance indicators γ_{bF} and γ_{cF} with the relative dimensions of assemblies 12 and 13. It is noticed that all the values of γ_{bF} and γ_{cF} are larger than one which indicates that assemblies 12 and 13 produce larger deflections than rectangular microcantilevers under same surface stress at the base and same length L. Moreover, both indicators increase as both the microcantilever width W and the assembly width B increase. Similar findings are noticed for the performance indicators γ_{bM}, γ_{cM}, γ_{bΔσ}, and γ_{cΔσ} as can be seen from graphs 60 and 70 shown respectively FIGS. 6 and 7. On the other hand, an increase in B causes the effective free length of the assembly to increase, which makes the assembly more pronounced to external noises.

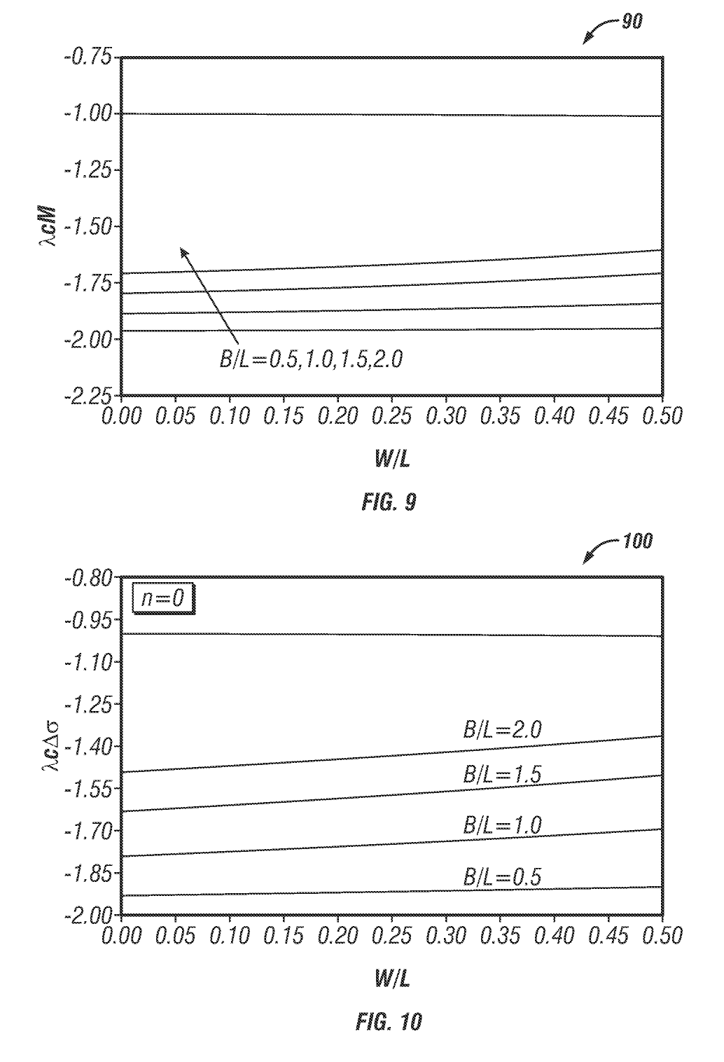

FIG. 8 illustrates a graph 80 depicting data indicative of the variation of the second performance indicator λ_{cF} with the relative dimensions of the epsilon shaped microcantilever assembly 13. It is noticed that all values of λ_{cF} are smaller than minus one. This indicates that IB-free end deflection is always larger than that of the assembly tip deflection. Moreover, the absolute value of λ_{cF} is noticed to increases as both W and B decreases. Similar findings are noticed for the performance indicators λ_{cM} and λ_{cΔσ} as can be seen from graphs 90 and 100 depicted respectively in FIGS. 9 and 10. As a result, the epsilon shaped microcantilever assembly 13 can provide larger deflections than the modified triangular microcantilever assembly 12, while it is less affected by external noise. This is because its deflection increases as B decreases, which results in a reduction of the assembly's free length. Moreover, the absolute values of λ_{cΔσ} increases as n increases as can be shown using Equation 234. This indicates the advantage of assembly 13 in microsensing applications as compared to rectangular cantilevers or triangular cantilevers.

Advantages of utilizing microcantilever assemblies including the ε-assembly in microsensing applications have been explored, as discussed herein. Various force loadings conditions that can produce noticeable deflections such as the concentrated force, moment and constant surface stress, which can be due to analyte adhesion, are considered. The linear elasticity theory for thin beams is used to obtain the deflections. Different deflection indicators are defined and various controlling variables are identified. The performance of different microcantilever assemblies is compared with the performance of rectangular microcantilevers in order to map out conditions that produce magnification of the sensing deflection relative to the noise deflection.

To the extent necessary to understand or complete the disclosure herein, all publications, patents, and patent applications mentioned herein are expressly incorporated by reference therein to the same extent as though each were individually so incorporated.

Having thus described exemplary embodiments of the present invention, it should be noted by those skilled in the art that the within disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. An epsilon-shaped microcantilever assembly, comprising:
a first side beam, a second side beam, and an intermediate beam, wherein the first side beam comprises an end attached to an end of the second side beam;
the intermediate beam comprising an end attached to the ends of the first and second side beams such that the intermediate beam is positioned between the first and second side beams;
wherein an end of the intermediate beam opposite to the attached ends of the first side beam, second side beam, and the intermediate beam are left free and are force-loaded;
wherein the first side beam, second side beam, and the intermediate beam each possess a top surface and a bottom surface; and
a receptor coated on the top surfaces of the first and second side beams and on the bottom surface of the intermediate beam.

2. The epsilon-shaped microcantilever assembly of claim 1 wherein varying force loadings including at least one of a concentrated force, a concentrated moment, and a constant surface stress are utilized with respect to the epsilon-shaped microcantilever assembly.

3. A method of forming an epsilon-shaped microcantilever assembly, the method comprising:
forming a first side beam, a second side beam, and an intermediate beam, wherein the first side beam comprises an end attached to an end of the second side beam;
configuring the intermediate beam to include an end attached to the ends of the first and second side beams such that the intermediate beam is positioned between the first and second side beams;
leaving the ends opposite to the attached end of the first side beam, second side beam, and intermediate beam free and are force-loaded;
configuring the first side beam, second side beam, and the intermediate beam to each possess a top surface and a bottom surface; and
coating a receptor on the top surfaces of the first and second side beams and on the bottom surface of the intermediate beam, such that the first side beam, the second side beam, and the intermediate beam form said epsilon-shaped microcantilever assembly.

4. The method of claim 3 further comprising validating obtained deflections of the epsilon-shaped assembly against an accurate numerical solution utilizing a finite element technique with a maximum deviation of less than approximately ten percent.
